(19) United States
(12) Patent Application Publication
(10) Pub. No.: US 2002/0115331 A1
(43) Pub. Date: Aug. 22, 2002

(54) Locking and releasable electrical receptacle connector

(76) Inventor: Su Yueh Ho, Flushing, NY (US)

Correspondence Address: HO SU Y., 144 - 51 29 AV., FLUSHING, NY, 11354, US

(21) Appl. No.: 09/681,209

(22) Filed: Feb. 22, 2001

(51) Int. Cl. H01R 4/50

(52) U.S. Cl. 439/346

(57) ABSTRACT

An electrical receptacle/connector with a releasable locking portion is disclosed. The contacts of the said receptacle/connector for the straight terminal blades/prongs of most standard plugs have protrusion knobs of which locks in the holes of the blades/prongs once it is plugged in. A push release button is used to push aside the protrusion knobs/contacts away from the holes of the blades, to release the blades, allowing it to be freed. This invention uses the fact that most standard plugs have a hole near the end of each of its blades/prongs.

### CROSS REFERENCE TO RELATED APPLICATIONS

There are no applications filed in this country or any foreign country.

### SUMMARY OF INVENTION

It is an objective of the present invention to provide the most economic and the easy manufacturability of the self-locking and releasable electrical receptacles/connectors for standard plugs, the invention has special protrusion knobs on the contacts inside the said body and the said contacts are contacting to the blades of the plug to transmit the electricity. Once the standard plug with a hole on each of the blades plug into the said receptacle/connector of the invention, the protrusion knobs will fit into the holes preventing the plug to be freed. When a release button is pushed, the protrusion knobs/contacts are pushed away from the holes of the blades, allowing the plug to be freed.

### BRIEF DESCRIPTION OF DRAWINGS

FIG. 1 is a perspective view of a version of the receptacle/connector of the invention. FIG. 2 is a cross section view, take along the line 2-2 of FIG. 1, and with parts omitted for clarity, showing the condition of the plug in locking position. FIG. 3 is a section view similar to FIG. 2, with the release button and spring added, showing the condition of the release button pushed in position. FIG. 4 is a perspective view of one version of the contact with a lock element (said protrusion knob) contemplated by the invention. FIG. 5 is a perspective view of another version of the contact with a different lock element (said protrusion knob) contemplated by the invention.

### DETAILED DESCRIPTION

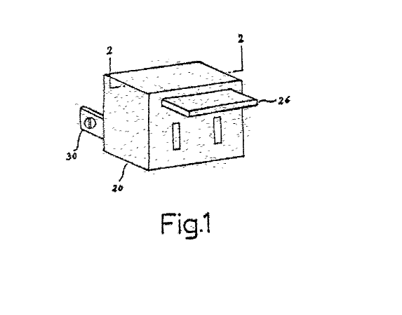

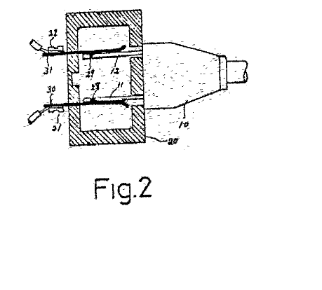

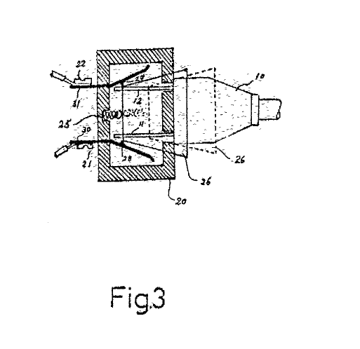

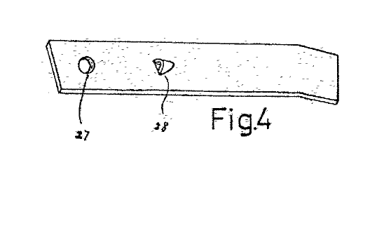

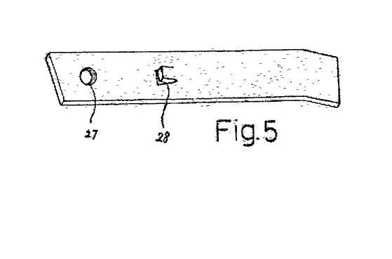

The receptacle/connector of this invention provides a secure means of connecting a plug to an outlet. The invention can be used with any type of standard electrical plug having straight terminal blades that has a hole each on the near the end of the blade. Referring to FIGS. 1 to 4 inclusively, their shows the first embodiment of the receptacle indicated at FIG. 1, consists of a casting body made of suitable non-conductive plastic or equivalent materials and assembled with two-said invention contact with lock elements (said protrusion knobs/contacts), a spring, and a release button. As shown in FIG. 2 the plug is inside the receptacle and in locking position with the release button and spring removed, for clarity purposes, 10 is a standard male plug, 20 (shaded area) is the body of the receptacle, 11 and 12 are the blades with holes, when the plug 10 goes into the receptacle, the blades 11 and 12 force open a spring-able contacts 30 and 31, once the blades are in position, protrusion knobs 28 and 29 fit into the holes of each blade of which the contacts are back to normal position to touch the blades to transmit the electricity, due to the angle of the forward side of protrusion knobs have less than 90 degree, the blades can slide and open the contacts, and the angle of the rearward of the protrusion knobs have near or bigger than 90 degree, once the protrusion knobs are in the holes of the blades, the plug cannot be pulled back out, thus locking the plug in place. As shown in FIG. 3, the release button and the spring was added to the drawing, showing the release button was pushed in and the contacts opened, the protrusion knobs/contacts are pushed away from the holes of the blades. The dotted line shows release button in normal position, whenever the plug needs to be pulled out, first push the release button from dotted line to solid line, which pushes the protrusion knobs/contacts away and out of the holes of the blades, thus leaving the blades free to be pulled out. Once the plug is out, let go of the release button, a spring will move the release button back to the normal position (dotted line) and the protrusion knobs/contacts move back to the position as shown in FIG. 2. As shown in FIG. 4 is the view of one of the invention's protrusion knob/contact, the contact is spring-able, 27 is the thread hole for screw 21 and for tight electrical wire, 28 is the said protrusion knob/contact. For easy manufacturing purpose, the protrusion knob can be made as a single piece of the contact on the rear side of the protrusion knob (the left side of drawing) pouched open and the forward side (the right side of drawing) as a hill. As shown in FIG. 5, is the view of another version of the said protrusion knob/contact to show a punch out of the protrusion knob/contact for clarity purposes.

What is claimed is:

1. A locking and releasable electrical receptacle/connector, suitable for use with a standard male electrical plug, and the blades of the plug has a hole on each of the blades, the locking and releasable receptacle/connector compromising; a body of having at least one contact for each blade of the plug to make the contact to transmit electricity. The said contacts have protrusion knobs that fit in the holes on the blades (while the plug inside the said receptacle/connector).

2. The said protrusion knobs has an angle bigger than 0° and smaller than 90° on its forward side and the rearward side of the said protrusion knobs should hold the holes of the blades, preventing it to be pulled back out when the protrusion knobs is within the holes of the blades; a movable element being accessible from the outside of the said body, engage to release the said protrusion knobs/contacts, allowing the blades to be freely pulled out.
